(19) United States
(12) Patent Application Publication
(10) Pub. No.: US 2025/0147774 A1
(43) Pub. Date: May 8, 2025

(54) CONTEXT AWARE SCALING IN A DISTRIBUTED SYSTEM

(71) Applicant: DELL PRODUCTS L.P., Round Rock, TX (US)

(72) Inventors: Parmeshwr Prasad, Bangalore (IN); Ravishankar N, Bangalore (IN); Anubhav Singh, Pune (IN)

(21) Appl. No.: 18/500,559

(22) Filed: Nov. 2, 2023

(51) Int. Cl. G06F 9/445

(52) U.S. Cl. CPC G06F 9/44505

(57) ABSTRACT

A distributed processing system includes a cloud-based network and a back-end system. The cloud-based network has an orchestrator and a plurality of application pods. Each application pod includes an application and an exporter configured to provide telemetry information for the associated application. The back-end system has an application analysis module that receives the telemetry information from the application pods, determines an interdependency between the applications, determines a scaling between the applications, and directs the orchestrator to launch the applications based on the scaling.

### FIELD OF THE DISCLOSURE

This disclosure generally relates to information handling systems, and more particularly relates to context aware scaling in a distributed network of information handling systems.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

A distributed processing system may include a cloud-based network and a back-end system. The cloud-based network may have an orchestrator and a plurality of application pods. Each application pod may include an application and an exporter configured to provide telemetry information for the associated application. The back-end system may have an application analysis module that receives the telemetry information from the application pods, determines an interdependency between the applications, determines a scaling between the applications, and directs the orchestrator to launch the applications based on the scaling.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a distributed processing system according to an embodiment of the current disclosure;

FIG. 2 is an illustration of an application wants matrix according to an embodiment of the current disclosure; and

FIG. 3 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

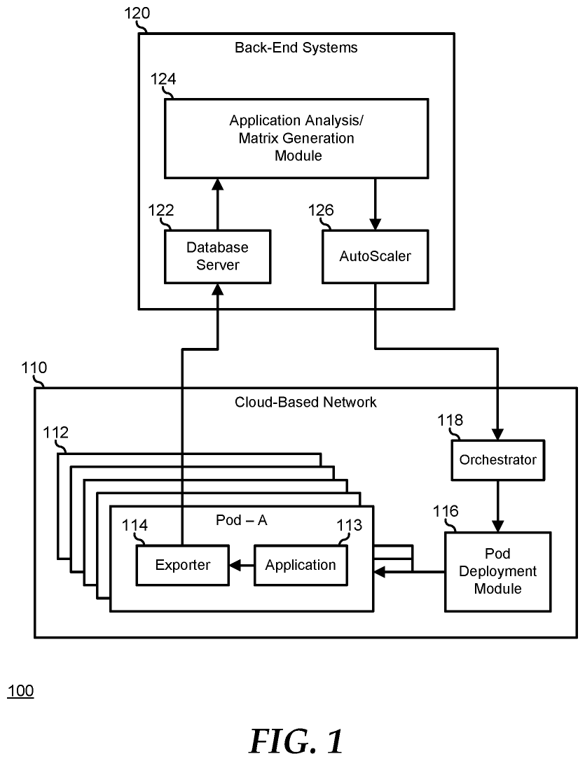

FIG. 1 illustrates a distributed processing system 100 including cloud based network 110 and a back-end system 120. Distributed processing system 100 represents a network of information handling systems that are provided to perform processing tasks that may span across the information handling systems, or may be otherwise implemented to perform the processing tasks. For example, distributed processing system 110 may include a number of client information handling systems, where the distributed processing system operates to optimize the performance of the processing tasks by performing some portions of the processing tasks in the client information handling systems, and other portions of the processing tasks in cloud-based systems, as needed or desired. For example, distributed processing system 100 may be provided to enable vehicle automation functions for a fleet of vehicles. Vehicle safety functions may be best performed on each particular vehicle, vehicle tracking and mapping functions may be best performed on near-edge systems of the distributed processing system, and vehicle entertainment functions may be best performed on far-edge systems. As such, the decision as to where various applications are performed within distributed processing system 100 may be dependent upon the processing demand of the applications, the network latency in executing the applications, the data bandwidth needed in executing the applications, the data storage requirements of the applications, or the like.

Cloud-based network 110 represents the information handling systems upon which the applications are executed, be they client information handling systems, near-edge systems, far-edge systems, or the like. Back-end system 120 represents one or more information handling system configured to provide services to cloud-based network 100, as described below. Cloud-based network 110 includes multiple pods 112, a pod deployment module 116, and an orchestrator module 118. Pods 112 represent the processing tasks that are distributed among the elements of cloud-based network 110. Pods 112 each include an application 113 and a telemetry exporter 114. In a particular embodiment, each one of pods 112 represents a container associated with a containerized architecture such as a Docker container system or the like, that is provided on distributed processing system 100 to perform a particular processing task utilizing included application 113. In another embodiment, pods 112 represent applications that are launched on a particular system of cloud-based network 110, as needed or desired. In yet another embodiment, pods 112 represent portions of a larger suite of applications that can be independently executed to provide the functionality of the suite of applications.

It has been understood by the inventors of the current disclosure that achieving application balance in a distributed processing system is largely determined by the horizontal scaling (processing in parallel across multiple systems) and the vertical scaling (splitting workload tasks hierarchically across multiple systems) of the applications within the distributed processing system. However, as typically performed, the evaluation of the overall performance of an application occurs without taking into account all of the related applications that get launched as a result of the launch of the initial application. For example, where a web server application is called that utilizes the services of a file transport application, the number of iterations of the file transport application may not scale sufficiently to support the traffic of the web server application.

In a particular embodiment, each pod 112 provides a customized exporter 114 associated with application 113 that exports telemetry from the application to database server 122. In particular exporter 114 is configured to monitor telemetry information from application 113 and to format the telemetry information into a form that is serviceable by database 122. The telemetry information may include application calls to other applications in other pods, error rates, network latencies, average load, CPU, memory, message throughput, or the like. Database server 122 operates to gather and store the telemetry information from multiple pods 112 for analysis by application analysis module 124. Exporter 114 is customized to provide the telemetry information most relevant to the scaling of applications 113, as needed or desired. Following is pseudocode for generating telemetry information from exporter 114.
Define database gauge metric for application
Register the metric with the database
Start a routine to periodically fetch the metric
While in the routine, do:
   Fetch the application metric from the application
   Set the values of the database metric
   Sleep for predetermined time before fetching the application metric again
Serve the database metric on a port
Define functions to application metric from the application

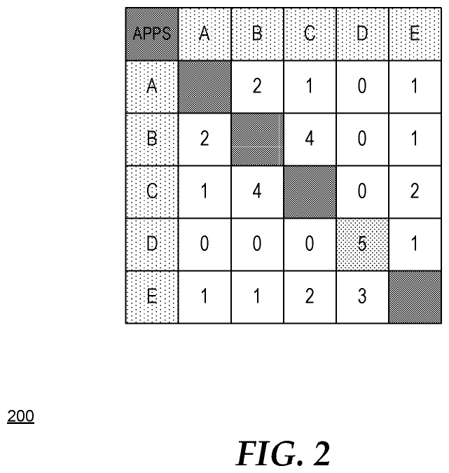

Application analysis module 124 operates to analyze the telemetry information from pods 112 to create an application wants matrix 200, as shown in FIG. 2. Then, based upon application wants matrix 200 and the telemetry information, autoscaler 126 determines the number of and type of applications 113 that need to be launched for the current conditions on cloud-based network 110. Autoscaler 126 then directs orchestrator 118 to launch the determined number and types of applications 113, and the orchestrator determines where on cloud-based network the applications are most efficiently launched, and directs pod deployment module 116 to launch the applications.

Application wants matrix 200 represents a result of the analysis of the telemetry information from pods 112 showing the scaling between applications 113. In a particular case, application analysis module 124 determines various static dependencies between applications 113. For example, where an application 113 represents a database front end for users of cloud-based network 110, application analysis module 124 may determine that any instance of the database front end invoked by a user may necessitate the invocation of a database write application, a database query application, and a database read application. Thus, in this example, application wants matrix 200 would have a root for the database front end application which would spawn a want for one instance of the database read application, one instance of the database query application, and one instance of the database write application. Then, for each instance that the database front-end application is launched, autoscaler 126 directs orchestrator 118 to also launch one instance of the database read application, one instance of the database query application, and one instance of the database write application on cloud-based network 110 based upon application wants matrix 200.

In another case, application analysis module 124 determines various dynamic dependencies between applications 113. For example, where application 113 is a web front-end application, application analysis module 124 may determine that a demand for a dependent application scales with the number of http requests that are received by the web front-end application. Then, when real time telemetry information from the web front-end indicates that the number of http requests received has exceeded a threshold, autoscaler 126 directs orchestrator 118 to launch the dependent application based on application wants matrix 200.

In yet another case, application analysis module 124 determines a static scaling for a particular application 113. For example, where application 113 represents a firmware or software updater, application analysis module 124 may determine that any update to a particular element of firmware will always be loaded to all of the processing elements of cloud-based network 110. Thus, where cloud-based network 110 includes five (5) systems of a particular type, application analysis module 124 may determine than any firmware update to that type of system will always be provided to all five (5) of those systems, and, based on application wants matrix 200, autoscaler 126 will direct orchestrator 118 to launch five (5) instances of the firmware update on the associated systems. An example of such is shown with respect to Application D in application wants matrix 200, where no other applications depend from Application D, but where a launch of Application D is shown as spawning five (5) launches of that application.

Application wants matrix 200 may be provided as a static analysis of the conditions on cloud-based network 110, or as a dynamic analysis, that is, a real-time analysis of the conditions on the cloud-based network, as needed or desired. Moreover application wants matrix 200 may represent a multidimensional matrix, where different conditions on cloud-based network 110 are each modeled by application analysis module 124 to create multiple application wants matrices, as needed or desired.

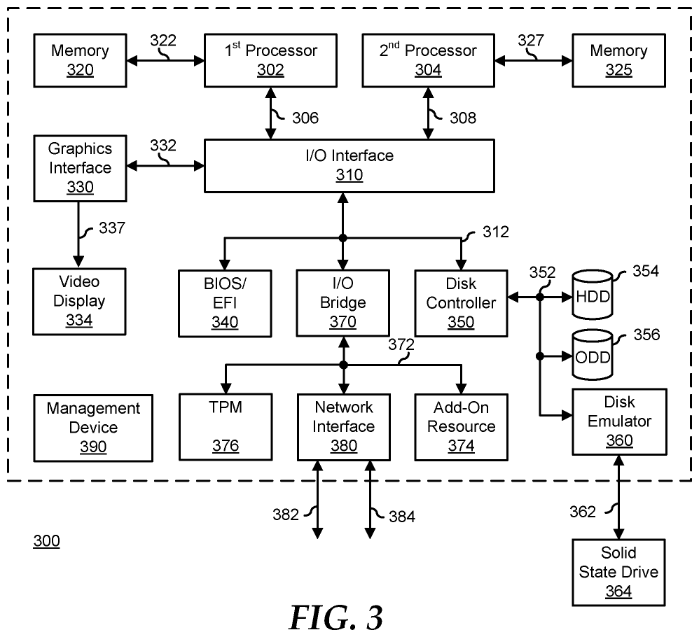

FIG. 3 illustrates a generalized embodiment of an information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware.

Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 364, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 364, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 325 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I′C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 2394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A distributed processing system, comprising:
a cloud-based network having an orchestrator and a plurality of application pods, each application pod including an application and an exporter configured to provide telemetry information for the associated application;
a back-end system having an application analysis module configured to receive the telemetry information from the application pods, to determine an interdependency between the applications, to determine a scaling between the applications, and to direct the orchestrator to launch the applications based on the scaling.

2. The distributed processing system of claim 1, wherein in determining the interdependency between the applications, the application analysis module is further configured to create an application wants matrix that correlates a first application with a number of instantiations of a second application.

3. The distributed processing system of claim 2, wherein the correlation between the applications is a static correlation.

4. The distributed processing system of claim 2, wherein the correlation between the applications is a time-based correlation.

5. The distributed processing system of claim 2, wherein the back-end system further includes an application scaler configured to direct the orchestrator to launch the number of instantiations of the second application when the first application is launched.

6. The distributed processing system of claim 1, wherein the telemetry information includes application calls to other applications in other application pods.

7. The distributed processing system of claim 6, wherein the telemetry information further includes one of an application error rate, an application network latency, a processor load, and a memory load.

8. The distributed processing system of claim 1, wherein the telemetry information is provided on a periodic basis.

9. The distributed processing system of claim 1, wherein the back-end system further includes a database configured to receive the telemetry information and to provide the telemetry information to the application analysis module.

10. The distributed network of claim 1, wherein each application pod provides a containerized instantiation of the associated application.

11. A method, comprising:
providing, in a distributed processing system, a cloud-based network having an orchestrator and a plurality of application pods, each application pod including an application and an exporter configured to provide telemetry information for the associated application;
providing, in the distributed processing system, a back-end system having an application analysis module;
receiving, by the application analysis module, the telemetry information from the application pods;
determining, by the application analysis module, an interdependency between the applications;
determining, by the application analysis module, a scaling between the applications; and
directing the orchestrator to launch the applications based on the scaling.

12. The method of claim 11, wherein in determining the interdependency between the applications, the method further comprises:
creating, by the application analysis module, an application wants matrix that correlates a first application with a number of instantiations of a second application.

13. The method of claim 12, wherein the correlation between the applications is a static correlation.

14. The method of claim 12, wherein the correlation between the applications is a time-based correlation.

15. The method of claim 12, further comprising:
providing, in the distributed processing system, an application scaler; and
directing, by the application scaler, the orchestrator to launch the number of instantiations of the second application when the first application is launched.

16. The method of claim 11, wherein the telemetry information includes application calls to other applications in other application pods.

17. The method of claim 16, wherein the telemetry information further includes one of an application error rate, an application network latency, a processor load, and a memory load.

18. The method of claim 11, wherein the telemetry information is provided on a periodic basis.

19. The method of claim 11, further comprising:
providing, in the distributed processing system, a database; and
storing, by the database, the telemetry information.

20. A distributed processing system, comprising:
a cloud-based network having an orchestrator and a plurality of application pods, each application pod including an application and an exporter configured to provide telemetry information for the associated application;
a back-end system having a database to store the telemetry information and an application analysis module configured to receive the telemetry information from the application pods, to determine an interdependency between the applications, to determine a scaling between the applications, and to direct the orchestrator to launch the applications based on the scaling, wherein in determining the interdependency between the applications, the application analysis module is further configured to create an application wants matrix that correlates a first application with a number of instantiations of a second application.
